(19) United States
(12) Patent Application Publication
(10) Pub. No.: US 2021/0214225 A1
(43) Pub. Date: Jul. 15, 2021

(54) COMPOSITE CARBON MATERIAL AND PREPARATION METHOD AND USE THEREOF

(71) Applicants: China Energy Investment Corporation Limited, Beijing (CN); National Institute of Clean-and-Low-Carbon Energy, Beijing (CN)

(72) Inventors: Peng LIANG, Beijing (CN); Wenbin LIANG, Beijing (CN); Chang WEI, Beijing (CN); Junqing LIU, Beijing (CN); Dongfang ZHENG, Beijing (CN); Chunting DUAN, Beijing (CN); Guanghong PAN, Beijing (CN)

(21) Appl. No.: 17/056,162

(22) PCT Filed: Aug. 13, 2018
(86) PCT No.: PCT/CN2018/100253

§ 371 Date: Nov. 17, 2020

(30) Foreign Application Priority Data
May 18, 2018 (CN) 201810482039.X

(51) Int. Cl. C01B 32/05; H01M 10/0525

(52) U.S. Cl. CPC C01B 32/05; H01M 10/0525; C01P 2004/61; C01P 2006/10; C01P 2002/82; C01P 2002/74

(57) ABSTRACT

A composite carbon material and a preparation method and a use thereof. The composite carbon material comprises a graphite crystal phase and an amorphous carbon phase, wherein the ratio I₀₀₂/Iₐₘₒᵣ of the peak intensity I₀₀₂ of the graphite crystal phase (002) plane relative to the peak intensity Iₐₘₒᵣ of the amorphous carbon phase as measured by the X-Ray Diffraction (XRD) is within a range of 0.1-40, and the content of the graphite crystal phase is not less than 5 wt %. The composite carbon material has high compressive strength, bending strength and thermal conductivity, and can be used as a heat dissipation material; the composite carbon material can also be used as an anode material of a lithium ion battery such that the lithium ion battery exhibits excellent electrochemical performance.

### FIELD

The present disclosure relates to the field of carbonaceous composite materials, in particular to a composite carbon material and a preparation method and a use thereof.

### BACKGROUND

The graphite-based composite materials are widely used in many fields due to their excellent properties. For example, the graphite-based. composite materials have a lower density, a higher thermal conductivity, and a lower thermal expansion coefficient than the metal materials, thus can be used as the heat dissipation materials for replacing the metals in the technical fields such as computer, communication equipment, integrated circuit and electronic package. The graphite-based composite materials have the characteristics of high electronic conductivity, large lithium ion diffusion coefficient, small volumetric change of a laminated structure before and after the lithium intercalation, high lithium intercalation capacity, low lithium intercalation potential and the like, thus the graphite-based composite materials have become the key anode materials of lithium ion battery at present; in addition, the graphite-based composite materials are also applied as the materials for manufacturing mechanical parts such as molds and indenters due to its excellent mechanical strength.

A variety of methods of preparing graphite-based composite materials have been developed for different applications of the materials.

CN106241775A discloses a graphite material, and a raw material composition, a preparation method and a use thereof. The preparation method for the graphite material comprises the following steps: subjecting the natural flake graphite, artificial graphite, mesosphere carbon microspheres and a binder to the mixing and kneading, extruding, crushing and screening processes so as to obtain matrix graphite powder; pressing the matrix graphite powder into a spherical green body; subjecting the green body to carbonization and purification so as to prepare the graphite material. The graphite material can be used as an outer shell material of a fuel element in a reactor.

CN101708838A discloses a highly oriented graphite material of a nature flake graphite base and a preparation method thereof. The preparation method comprises the following steps: subjecting the natural graphite, an adhesive and a solvent to mixing and grinding; carrying out drying, hot-press forming in a mould, and finally carbonizing and graphitizing to obtain the highly oriented graphite material. The graphite material can be used as a heat dissipation material.

CN106252596A discloses a composite soft carbon graphite composite anode material, a preparation method thereof, and a lithium ion battery. The preparation method comprises the following steps: mixing natural spherical graphite and asphalt, heating and dipping under a preset pressure to allow the asphalt to be softened and to flow into and fill inner pores of the natural spherical graphite, and cooling to obtain an intermediate; sequentially carbonizing the intermediate, crushing and grading to obtain the composite anode material.

The above patent documents disclose a variety of graphite-based composite materials and methods for preparing the same, which not only have various operation steps but also have difficulty to achieve uniform dispersion of graphite in a matrix at a nanometer level, and the prepared graphite-based composite materials can be only used in specific fields.

### SUMMARY

In view of solving the above problems in the prior art, the present disclosure aims to provide a novel composite carbon material, and a preparation method and a use thereof. The inventors of the present disclosure have discovered in their researches that a graphite-based composite material can be obtained by controlling the ratio of the peak intensity of the graphite crystal phase (002) plane relative to the peak intensity of the amorphous carbon phase within a certain range, the obtained graphite-based composite material has excellent mechanical properties and heat dissipation performance, and the electrochemical performance of a battery can be improved by applying the graphite-based composite material as an anode material for a lithium ion battery. Based. on the discovery, the present disclosure is filed.

According to a first aspect, the present disclosure provides a composite carbon material comprising a graphite crystal phase and an amorphous carbon phase, wherein the ratio I₀₀₂/Iₐₘₒᵣ of the peak intensity I₀₀₂ of the graphite crystal phase (002) plane relative to the peak intensity Iₐₘₒᵣ of the amorphous carbon phase as measured by the X-Ray Diffraction (XRD) is within a range of 0.1-40, and the content of the graphite crystal phase is not less than 5 wt %.

According to a second aspect, the present disclosure provides a method of preparing the composite carbon material, and the method comprising the following steps:

1) subjecting a matrix material and a filler to multi-stage mixing so as to obtain a mixture, wherein the multi-stage mixing comprises:

(1) mixing the matrix material and the filler under an ambient temperature for 1-6 hours; then

(2) blending the matrix material and the filler for 0.5-3 hours in the process of heating to 10-50° C. higher than the softening temperature of the matrix material; then

(3) blending the matrix material and the filler for 2-10 hours at the constant temperature of 10-50° C. higher than the softening temperature of the matrix material; and then

(4) blending the matrix material and the filler for 0.5-3 hours in the process of cooling to the ambient temperature;

circulating the stages (1) to (4) for multiple times, and the total time of the multi-stage mixing is within a range of 10-150 hours;

2-1) oxidizing the mixture, and subsequently carrying out carbonization in a carbonization furnace; or

2-2) subjecting the mixture to the mould pressing carbonization in a mould;

the matrix material forms the amorphous carbon phase by carbonization, and the filler is selected from graphite and/or graphene.

According to a third aspect, the present disclosure provides a composite carbon material produced with the method according to the second aspect of the present disclosure.

According to a fourth aspect, the present disclosure provides a method of using the composite carbon material of the present disclosure in a heat dissipation material or a lithium ion battery.

The composite carbon material has high compressive strength, bending strength and thermal conductivity, so that it can be used as a heat dissipation material; the composite carbon material can also be used as an anode material of a lithium ion battery, and the lithium ion battery containing the composite carbon material exhibits excellent electrochemical performance. In addition, the method of the present disclosure can perform the uniform dispersion of graphite in the matrix with the thickness of nanometer level.

### BRIEF DESCRIPTION OF THE DRAWINGS

FIG. 1 is a Transmission Electron Microscopy (TEM) image of a composite carbon material prepared in Example 4.

FIG. 2 is a partial enlarged diagram of the TEM image of the composite carbon material prepared in Example 4.

### DETAILED DESCRIPTION

The terminals and any value of the ranges disclosed herein are not limited to the precise ranges or values, such ranges or values shall be comprehended as comprising the values adjacent to the ranges or values. As for numerical ranges, the endpoint values of the various ranges, the endpoint values and the individual point values of the various ranges, and the individual point values may be combined with one another to produce one or more new numerical ranges, which should be deemed have been specifically disclosed herein.

According to a first aspect, the present disclosure provides a composite carbon material comprising a graphite crystal phase and an amorphous carbon phase, wherein the ratio I₀₀₂/Iₐₘₒᵣ of the peak intensity I₀₀₂ of the graphite crystal phase (002) plane relative to the peak intensity Iₐₘₒᵣ of the amorphous carbon phase as measured by the X-Ray Diffraction (XRD) is within a range of 0.1-40 and the content of the graphite crystal phase is not less than 5 wt %.

In the present disclosure, the content of the graphite crystal phase is determined according to the feeding amount in the preparation of the silicon-carbon composite material.

In the composite carbon material of the present disclosure, the peak intensity I₀₀₂ of the graphite crystal phase (002) plane and the peak intensity Iₐₘₒᵣ of the amorphous carbon phase are measured by the following conventional methods: carrying out XRD detection in regard to the powder sample to obtain an XRD spectrogram and XRD data of the sample, using the Topas software for automatically deducting the background, carrying out peak-differentiation-fitting so as to obtain a peak of a graphite crystal phase (002) plane and a peak of an amorphous carbon phase, and reading the corresponding intensities.

In the composite carbon material of the present disclosure, the ratio I₀₀₂/Iₐₘₒᵣ of the peak intensity I₀₀₂ of the graphite crystal phase (002) plane relative to the peak intensity Iₐₘₒᵣ of the amorphous carbon phase is preferably within a range of 0.5-38, and more preferably 3-38.

In the composite carbon material of the present disclosure, the normalized ratio I₀₀₂/Iₐₘₒᵣ of the peak intensity I₀₀₂ of the graphite crystal phase (002) plane relative to the peak intensity Iₐₘₒᵣ of the amorphous carbon phase may be within a range of 0.0-60.

It shall be comprehended by those skilled in the art that the normalized ratio I₀₀₂/Iₐₘₒᵣ can circumvent the influences of the content of different components of the material on the intensity ratio.

In the present disclosure, the normalized ratio I₀₀₂/Iₐₘₒᵣ is determined according to Formula (1):

Normalized ratio I₀₀₂/Iₐₘₒᵣ=(I₀₀₂/Wf_{G})/(Iₐₘₒᵣ/Wf_{D}) Formula (1)

Wherein Wf_{G} represents the mass percentage of the filler (for forming a graphite crystal phase) used in the preparation of the composite carbon material relative to the sum of the filler and the matrix material (for forming an amorphous carbon phase);

Wf_{D} represents the mass percentage of the matrix material used in the preparation of the composite carbon material in the total of the filler and the matrix material.

In the composite carbon material, the normalized ratio I₀₀₂/Iₐₘₒᵣ or the peak intensity I₀₀₂ of the graphite crystal phase (002) plane relative to the peak intensity Iₐₘₒᵣ of the amorphous carbon phase is preferably within a range of 5-45, more preferably 7-22.

In the composite carbon material of the present disclosure, the ratio I₀₀₂/FWHM of the peak intensity I₀₀₂ of the graphite crystal phase (002) plane relative to the full width at half maximum (FWHM) of the peak, as measured by XRD, is within a range of 1,000-80,000. Wherein the ratio I₀₀₂/FWHM reflects the characteristic of the peak of the graphite crystal phase (002) plane in the XRD diffraction spectrum.

In the composite carbon material, the ratio I₀₀₂/FWHM of the peak intensity I₀₀₂ of the graphite crystal phase (002) plane relative to the full width at half maximum (FWHM) of the peak, as measured lay XRD, is preferably within a range of 2,000-75,000, further preferably 6,000-65,000, and even more preferably 8,000-60,000.

According to an embodiment, in the composite carbon material, the graphite interlayer spacing d₀₀₂ of the graphite crystal phase (002) plane as measured by XRD is within a range of 0.335-0.345 nm, and the crystal grain size Lc of the c-axis crystal plane of the graphite crystal phase is within a range of 5-35nm.

In the composite carbon material of the present disclosure, the dispersion coefficient δ of the ratio Id/Ig of Id and Ig as measured by Raman spectrum is less than 0.8. The dispersion coefficient δ indicates a very uniform dispersion between the graphitic crystalline phase and the amorphous carbon phase.

In the present disclosure, the dispersion coefficient δ is determined by means of the following steps:

I: determining values Id and Ig of the Raman spectrum at 20 different locations in the sample;

II: calculating value Id/Ig of the 20 positions and marking the values as μ₁, μ₂, . . . μ₂₀, respectively, and calculating the average value μ according to a Formula (2):

μ=(μ₁+μ₂+ . . . +μ₂₀)/20, Formula (2)

III: calculating the standard deviation σ according to a Formula (3):

σ=sqrt{[μ₁−μ)²+(μ₂−μ)²+ . . . +(μₙ−μ)²]/n}, Formula (3)

Wherein the symbol sqrt represents a square root;

IV: calculating the dispersion coefficient δ according to a Formula (4):

δ=σ/μ, Formula (4).

In the composite carbon material, the dispersion coefficient δ is generally at least 0.01. Preferably, the dispersion coefficient δ is within a range of 0.02-0.6, further preferably 0.04-0.45, and even more preferably 0.05-0.35.

In the composite carbon material of the present disclosure, the graphitic crystal phase is dispersed in the amorphous carbon phase in a thickness of nanometer level, and in general, the thickness of the graphitic crystal phase may be within a range of 1-40 nm, preferably 5-30 nm, and more preferably 5-25 nm.

In the present disclosure, the thickness of the graphite crystal phase is measured by the High Resolution Transmission Electron Microscopy (HR-TEM).

According to an embodiment, the true density ρ of the composite carbon material is within a range of 1.8-2.3 g/cm³.

According to a second aspect, the present disclosure provides a method of producing the composite carbon material, and the method comprising the following steps:

1) subjecting a matrix material and a filler to multi-stage mixing so as to obtain a mixture, wherein the multi-stage mixing comprises:

(1) mixing the matrix material and the filler under an ambient temperature (15-45° C.) for 1-6 hours; then

(2) blending the matrix material and the filler for 0.5-3 hours in the process of heating to 10-50° C. higher than the softening temperature of the matrix material; then

(3) blending the matrix material and the filler for 2-10 hours at the constant temperature of 10-50° C. higher than the softening temperature of the matrix material; and then

(4) blending the matrix material and the filler for 0.5-3 hours in the process of cooling to the ambient temperature;

circulating the stages (1) to (4) for multiple times, and the total time of the multi-stage mixing is within a range of 10-150 hours;

2-1) oxidizing the mixture, and subsequently carrying out carbonization in a carbonization furnace; or

2-2) subjecting the mixture to the mould pressing carbonization in a mould.

The matrix material is not particularly limited in the present disclosure as long as it can limn the amorphous carbon phase after carbonization. Typically, the matrix material may be one or more selected from the group consisting of petroleum asphalt, coal pitch, mesophase pitch, Direct Coal Liquefaction Residue (DCLR), heavy aromatic hydrocarbons, epoxy resins, phenolic resins, urea-formaldehyde resins, furfural resins, polyvinyl alcohol, polyethylene glycol, polyvinylidene fluoride and polyacrylonitrile.

The softening temperature herein is defined according to the kind of the matrix material, it refers to a temperature at which the matrix material can flow, for example, when the matrix material is selected from the above-mentioned asphalts or thermosetting resins, the softening temperature refers to its softening point; when the matrix material is the above-mentioned thermoplastic resin, the softening temperature refers to its melting point,

Preferably, the matrix material is at least one of petroleum asphalt, coal pitch and mesophase pitch. The softening point of the coal pitch may be within a range of 80-360° C., preferably 100-320° C. the softening point of the petroleum asphalt may be within a range of 80-360° C., preferably 100-320° C.; the softening point of the mesophase pitch may be within a range of 180-360° C. In addition, the mesophase content in the mesophase pitch is usually within a range of 30-100 vol %.

According to the method of the present disclosure, the graphite, graphene as a filler is utilized to form a graphite crystal phase in the composite carbon material. Wherein the graphite may be one or more selected from the group consisting of natural graphite, artificial graphite, expanded graphite and graphite oxide. Typically; the carbon content in the graphite is 90 wt % or more. The number of graphene layers is preferably 20 or less.

According to a preferred embodiment, the matrix material in step 1) is at least one selected from the group consisting of coal pitch, petroleum asphalt and mesophase pitch. The matrix material and the filler are in the particulate form prior to the multi-stage mixing.

The mesh number of the matrix material is more than 50 meshes (i.e., 270 μm pore size screen underflow), and the preferred mesh number is 100-300 meshes. For example, the asphalt particles as the matrix material have a particle size of −50 meshes, −200 meshes (i.e., 150 μm pore size screen underflow), −150 meshes (106 μm pore size screen underflow), −200 mesh (75 μm pore size screen underflow), −300 mesh (48 μm pore size screen underflow). The asphalt having the particle size may be commercially available, or may be obtained by pulverizing and sieving in advance.

The mesh number of the filler is more than 80 meshes (i.e., 180 μm pore size screen underflow), and preferably 80-200 meshes. For example, the filler particles have a particle size of −100 meshes, −150 meshes, −200 meshes. The morphology of the filler is not particularly limited in the present disclosure, it may have any geometric shape, such as, but not limited to, spherical, sheet-shaped, cylindrical, polyhedral and the like. The filler having the above particle size may be commercially available, or may be prepared by pulverizing and sieving in advance.

According to the method of the present disclosure, the matrix material and the filler in step 1) are used in such an amount that the content of the graphite crystal phase filler) in the resulting composite carbon material is not less than 5 wt %. Typically the mass ratio of matrix material to filler may be 1:0.1-5, preferably 1:0.25-1.

In the step 1), the multi-stage mixing is performed by adjusting the temperature stepwise during the mixing process. It should be understood by those skilled in the art that the stage (2) “blending the matrix material and the filler for 0.5-3 hours in the process of heating to 10-50° C. higher than the softening temperature of the matrix material” means that the ambient temperature is used as the starting temperature, the temperature is gradually raised to a temperature of 10-50° C. higher than the softening temperature of the matrix material, which may be regarded as the final temperature of the step during the mixing process, and the temperature rise process of the step takes 0.5-3 hours; the stage (4) “blending the matrix material and the filler for 0.5-3 hours in the process of cooling to the ambient temperature” means that the process of gradually cooling from the constant temperature of the stage (3) to the ambient temperature takes a total of 0.5-3 hours during the mixing process.

In the present disclosure, the temperature rise in the stage (2) is preferably a temperature rise with an constant speed, and the temperature reduction in the stage (4) is preferably a temperature reduction with an constant speed.

In the step 1), the multi-stage mixing is performed by means of one of ball milling, blending-kneading and banburying or a combination thereof. The multi-stage mixing can be carried out under protection of an inert atmosphere or under vacuum conditions. The inert atmosphere is, for example, at least one selected from the group consisting of nitrogen gas, argon gas, helium gas, neon gas and krypton gas.

In the step 1), the mixing process is performed sequentially according to the four stages, namely stage (1), stage (2), stage (3) and stage (4), the four stages form a cycle, and the cycle is circulated for a plurality of times, for example, the number of circulations is 2-9 times (i.e., the mixing is performed for 3-10 times). Preferably, the total time of the multi-stage mixing is within a range of 50-130 hours.

According to an embodiment, the mixing is carried out by means of ball milling, the rotation speed of the ball mill may be controlled. within a range of 100-1,000 rpm, preferably 300-800 rpm; the revolution speed may be controlled within a range of 50-400 rpm, preferably 100-400 rpm.

According to another embodiment, the mixing is performed by the blending-kneading, and the rotation speed of the kneader is preferably within a range of 50-500 rpm, more preferably 200-500 rpm.

According to a further preferred embodiment, the mixing is carried out by banburying, the rotation speed of the banbury mixer is preferably within a range of 50-500 rpm, more preferably 200-500 rpm.

In the step 2-1), the operation of oxidation and the conditions thereof are not particularly limited in the present disclosure, both may be selected by referring to the prior art.

According to one embodiment, the oxidation is performed in an oxidizing atmosphere, the temperature of the oxidation may be within a range of 220-350° C., and the oxidation time may be 1-16 hours, preferably 5-12 hours. The oxidizing atmosphere is, for example, air or oxygen.

According to another embodiment, the oxidation is performed in a strong oxidizing acid, the temperature of the oxidation may be within a range of 25-100° C., and the oxidation time may be within a range of 0.5-12 hours, The non-limiting examples of the strong oxidizing acid include concentrated nitric acid, a mixture of concentrated nitric acid and concentrated sulfuric acid (e.g., a mixture of concentrated nitric acid and concentrated sulfuric acid in a volume ratio 1:3), and a mixture of concentrated nitric acid and concentrated hydrochloric acid (e.g., aqua regia). In the embodiment, step 2-1) may further include: washing the product obtained by oxidation with water to be neutral (pH is 6-8) and drying the washed product before carbonization. Preferably, the strong oxidizing acid is concentrated nitric acid.

It shall be comprehended by those skilled in the art that the purpose of the oxidation treatment is to obtain a product that is no longer meltable. The term “no longer meltable” has the general meaning in the field of carbon-based composite material production, and means that the product obtained by oxidation treatment does not soften or have fluidity under any heating conditions.

In the step 2-1), the carbonization is performed in a carbonization furnace, and the carbonization temperature may be within a range of 600-1,600° C., preferably 750-1,450° C.; the carbonization time may be within a range of 1-10 hours, preferably 1-8 hours,

In the step 2-2), the carbonization temperature in the mould pressing carbonization may be within a range of 600-1,600° C., preferably. 750-1,450° C., and the pressure applied to the surface of the mixture may be within a range of 10-50 MPa, preferably 10-40 MPa; the carbonization time may be within a range of 1-10 hours, preferably 1-8 hours.

In step 2-1) and step 2-2), the carbonization is generally performed under protection of an inert atmosphere. The inert atmosphere is as described above and the content is not repeated here.

According to the method of the present disclosure, depending on the practical use of the composite carbon material, the method may further comprise: 3) subjecting the carbonized product obtained in step 2-1) or step 2-2) (i.e., the composite carbon material of the present disclosure) to pulverization and grading.

In step 3), the pulverization may be performed by a ball mill or a jet mill.

Preferably, the median particle size of the powder obtained by the step 3) is within a range of 5-20 μm.

According to a third aspect, the present disclosure provides a composite carbon material produced with the method.

According to a fourth aspect, the present disclosure provides a use of the composite carbon material in a heat dissipation material or a lithium ion battery.

The composite carbon material provided by the present disclosure has high compressive strength, bending strength and thermal conductivity, thus the composite carbon material can be used as a heat dissipation material. The composite carbon material is used as an anode material for a lithium ion battery, so that the lithium ion battery has higher capacity retention rate, namely the electrochemical performance of the battery is improved.

The present disclosure will be described in detail below with reference to the examples.

In the following examples and comparative examples,

1. Devices

1) The banbury mixer was purchased from Dongguan Lixian Instrument Technology Co., Ltd., with the model number HZ-7048;

2) The kneader was a Thermo scientific™ purchased from Thermo Fisher Scientific Inc., with the model number HAAKE PolyLab Rheomex 600 OS;

3) The ball mill was purchased from Changshan MeaSure Instruments Equipment Co., Ltd., with the model number QM-QX 2L;

4) The jet mill was purchased from Weifang Aipa Powder Technology Equipment Co., Ltd., with the model number MQW 03.

2. The softening points of asphalts were measured according to D 3104-99 Standard Test Method for Softening Point of Pitches as stipulated by the American Society for Testing Material (ASTM).

3. Characterization of the Composite Carbon Material.

1) Testing the true density: the true density was measured by the true densitometer AccuPyc® II 1340 manufactured by the Micrometrics Instrument Corporation in USA at the temperature of 25° C.

2) XRD test: the test was carried out by a D8 ADVANCE X-ray diffractometer manufactured by the Bruker AXS GmbH in Germany, with copper Kα radiation over a scanning angle range of 10-90° and a step of 0.02.

3) TEM test: the sample was ground into a fine powder, loaded on a copper mesh, and measured by a JEM 2100 High Resolution. Transmission Electron Microscope (HR-TEM) manufactured by the JEOL Ltd, in Japan.

4) Raman spectrum: the testing was performed by a LabRam HR-800 microscopy laser confocal Raman spectrometer manufactured by the Horiba Jobin Yvon S.A.S in France, wherein the laser wavelength was 532.06 nm, the slit width was 100 μm, the scanning range was 700-2,100 cm ⁻¹, values Id and Ig were obtained through the Raman spectrum analysis;

Wherein the powder sample of the composite carbon material to be tested was flatly laid in a sample pool, 20 randomly distributed points in the sample were respectively measured to obtain the corresponding Id/Ig values; the dispersion coefficient δ of the Id/Ig values was then calculated according to the previously mentioned calculation method.

5) The compressive strength and the bending strength were measured by a model 5966 universal material testing machine manufactured by the Instron Corporation according to the following criteria:

GB/T 13465.1-2014 Part 1 of Test Methods for Impervious Graphite Materials: General Rules of Mechanical Property Testing Methods;

GB/T 13465.2-2014 Part 2 of Test Methods for Impervious Graphite Materials: Bending Strength;

GB/T 13465.3-2014 Part 3 of Test Methods for Impervious Graphite Materials: Compressive Strength.

6) Thermal conductivity: the measurement was carried out by means of the LFA 467 HyperFlash flash thermal conductivity apparatus manufactured by the NETZSCH Group in Germany according to the method in the standard ASTM E1461-2011.

4. Lithium Ion Battery Property Test (Capacity Retention Rate)

The test was performed with a battery test system LAND CT2001A manufactured by the Wuhan LAND Electronic Co., Ltd., the charging and discharging voltage range was 0-3V;

The discharge capacity at 0.1 C was initially tested, the average value obtained by 20 tests was calculated, the discharge capacity at 2C was then tested, and the average value of 20 tests was calculated; the ratio of the average value of the discharge capacity at 2C relative to the average value of the discharge capacity at 0.1C was marked as the discharge capacity retention rate.

### Example 1

The example was used for illustrating the composite carbon material and the method for producing the same according to the present disclosure.

The preparation method comprises the following steps: the petroleum asphalt with a softening point of 150° C. was used as a matrix material, the asphalt was subjected to crushing and the crushed asphalt was subjected to sieving by a 150-mesh sieve, the obtained screen underflow particles and the natural graphite (150-mesh sieve screen underflow particles, with a carbon content more than or equal to 99.5 wt %) were subjected to stirring and mixing at an ambient temperature according to a mass ratio of 4:1, the mixture was added into a kneader, the mixture was initially processed at an ambient temperature for 3 hours at a rotation speed of 500 rpm under the protection of nitrogen gas, the mixture was then processed for 1 hour in the process of heating to 160° C. at a constant speed, the mixture was subsequently processed at a constant temperature of 160° C. for 3 hours, the mixture was finally processed for 1 hour in the process of cooling to an ambient temperature at a constant speed, the process was circulated for 9 times, and the mixture was subjected to kneading in a total of 72 hours.

The mixture obtained by kneading was placed in a mould and heated to 1400° C. under the protection of nitrogen gas, and a pressure of 10 MPa was applied to the surface of the mixture, the temperature and pressure were kept for 1 hour, and then cooled, thereby obtaining a composite carbon material. The characterization results and properties of the composite carbon material were shown in Table 1.

### Example 2

The example was used for illustrating the composite carbon material and the method for producing the same according to the present disclosure.

The preparation method comprises the following steps: the coal pitch with a softening point of 200° C. was used as a matrix material, the pitch was subjected to crushing and the crushed pitch was subjected to sieving by a 200-mesh sieve, the obtained screen underflow particles and the artificial graphite (200-mesh sieve screen underflow particles, with a carbon content more than 99 wt %) were subjected to stirring and mixing at an ambient temperature according to a mass ratio of 3:2, the mixture was added into a ball mill, the mixture was initially subjected to ball milling at an ambient temperature for 3 hours at a rotation speed of 800 rpm and a revolution rotation speed of 200 rpm under the protection of nitrogen gas, the mixture was then subjected to the ball milling for 1.5 hour in the process of heating to 220° C. at a constant speed, the mixture was subsequently subjected to ball mill at a constant temperature of 220° C. for 10 hours, the mixture was finally subjected to ball milling for 1.5 hours in the process of cooling to an ambient temperature at a constant speed, the process was circulated for 6 times, and the mixture was subjected to ball milling in a total of 96 hours.

The mixture obtained by ball milling was placed in a mould and heated to 800° C. under the protection of nitrogen gas, and a pressure of 10 MPa was applied to the surface of the mixture, the temperature and pressure were kept for 1 hour, and then cooled, thereby obtaining a composite carbon material. The characterization results and properties of the composite carbon material were shown in Table 1.

### Comparative Example 1

The preparation method comprises the following steps: the coal pitch with a softening point of 200° C. was used as a matrix material, the pitch was subjected to crushing and the crushed pitch was subjected to sieving by a 200-mesh sieve, the obtained screen underflow particles and the natural graphite (200-mesh sieve screen underflow particles, with a carbon content more than 99 wt %) were subjected to stirring and mixing at an ambient temperature according to a mass ratio of 3:2, the mixture was added into a ball mill, the mixture was initially subjected to ball milling at an ambient temperature for 12 hours at a rotation speed of 800 rpm and a revolution rotation speed of 200 rpm under the protection of nitrogen gas, the mixture was then subjected to the ball milling for 1.5 hours in the process of heating to 220° C., the mixture was subsequently subjected to ball milling at a constant temperature of 220° C. for 1 hour, the mixture was finally subjected to ball milling for 1.5 hours in the process of cooling to an ambient temperature, the process was circulated for 6 times, and the mixture was subjected to ball milling in a total of 96 hours.

The mixture obtained by ball milling was placed in a mould and heated to 800° C. under the protection of nitrogen gas, and a pressure of 10 MPa was applied to the surface of the mixture, the temperature and pressure were kept for 1 hour, and then cooled, thereby obtaining a composite carbon material. The characterization results and properties of the composite carbon material were shown in Table 1.

### Comparative Example 2

The preparation method comprises the following steps: the coal pitch with a softening point of 200° C. was used as a matrix material, the pitch was subjected to crushing and the crushed pitch was subjected to sieving by a 200-mesh sieve, the obtained screen underflow particles and the artificial graphite (200-mesh sieve screen underfloor particles, with a carbon content more than 99 wt %) were subjected to stirring and mixing at an ambient temperature according to a mass ratio of 3:2, the mixture was added into a ball mill, the mixture was subjected to ball milling at an ambient temperature for 96 hours at a rotation speed of 800 rpm and a revolution rotation speed of 200 rpm under the protection of nitrogen gas.

The mixture obtained by ball milling was placed in a mould and heated to 800° C. under the protection of nitrogen gas, and a pressure of 10 MPa was applied to the surface of the mixture, the temperature and pressure were kept for 1 hour, and then cooled, thereby obtaining a composite carbon material. The characterization results and properties of the composite carbon material were shown in Table 1.

### Example 3

The example was used for illustrating the composite carbon material and the method for producing the same according to the present disclosure.

The preparation method comprises the following steps: the petroleum asphalt with a softening point of 220° C. was used as a matrix material, the asphalt was subjected to crushing and the crushed asphalt was subjected to sieving by a 150-mesh sieve, the obtained screen underflow particles and a mixture of the natural graphite/the graphene (the mass ratio was 5:1, the natural graphite was 200-mesh screen underflow particles, with a carbon content more than 99 wt %, and the thickness of the graphene was less than 10 layers) were subjected to stirring and mixing at an ambient temperature according to a mass ratio of 1:1, the mixture was added into a banbury mixer, the mixture was initially processed at an ambient temperature for 3 hours at a rotation speed of 300 rpm under the protection of nitrogen gas, the mixture was then processed for 2 hours in the process of heating to 250° C. at a constant speed, the mixture was subsequently processed at a constant temperature of 250° C. for 8 hours, the mixture was finally processed for 2 hours in the process of cooling to an ambient temperature at a constant speed, the process was circulated for 8 times, and the mixture was subjected to banburying in a total of 120 hours.

The mixture obtained by banburying was placed in a mould and heated to 1600° C. under the protection of nitrogen gas, and a pressure of 40 MPa was applied to the surface of the mixture, the temperature and pressure were kept for 2 hours, and then cooled, thereby obtaining a composite carbon material. The characterization results and properties of the composite carbon material were shown in Table 1.

### Example 4

The example was used for illustrating the composite carbon material and the method for producing the same according to the present disclosure.

The preparation method comprises the following steps: the mesophase pitch (having a mesophase content of 60 vol %) with a softening point of 280° C. was used as a matrix material, the pitch was subjected to crushing and the crushed pitch was subjected to sieving by a 100-mesh sieve, the obtained screen underflow particles and a mixture of the expanded graphite/the natural graphite (the mass ratio was 1:2, both the expanded graphite and the natural graphite were 100-mesh screen underflow particles, with a carbon content more than 99 wt %) were subjected to stirring and mixing at an ambient temperature according to a mass ratio of 4:1, the mixture was added into a ball mill, the mixture was initially subjected to bail milling at an ambient temperature for 2 hours at a rotation speed of 600 rpm and a revolution speed of 400 rpm under the protection of nitrogen gas, the mixture was then subjected to ball milling for 3 hours in the process of heating to 300° C. at a constant speed, the mixture was subsequently subjected to ball milling at a constant temperature of 300° C. for 4 hours, the mixture was finally subjected to ball milling for 3 hours in the process of cooling to an ambient temperature at a constant speed, the process was circulated for 6 times, and the mixture was subjected to ball milling in a total of 72 hours.

The mixture obtained by ball milling was placed in a mould and heated to 1,300° C. under the protection of nitrogen gas, and a pressure of 30 MPa was applied to the surface of the mixture, the temperature and pressure were kept for 4 hours, and then cooled, thereby obtaining a composite carbon material. The characterization results and properties of the composite carbon material were shown in Table 1.

TABLE 1

| | | | Comparative | Comparative | | |
|---|---|---|---|---|---|---|
| Items | Example 1 | Example 2 | Example 1 | Example 2 | Example 3 | Example 4 |
| d₀₀₂ (nm) of crystal | 0.336 | 0.337 | 0.335 | 0.337 | 0.337 | 0.342 |
| phase | | | | | | |
| Crystal phase | 16.9 | 29.1 | 126.1 | 86.6 | 30.9 | 16.9 |
| crystalline grain size | | | | | | |
| Lc (nm) | | | | | | |
| I₀₀₂/FWHM | 42,574 | 32,751 | 329,319 | 161,240 | 25,800 | 29,460 |
| I₀₀₂/Iₐₘₒᵣ | 3.2 | 5.2 | 95.3 | 42.5 | 3.1 | 37.2 |
| Normalized I₀₀₂/Iₐₘₒᵣ | 12.8 | 7.8 | 143.0 | 63.8 | 15.5 | 18.6 |
| Dispersion coefficient | 0.33 | 0.21 | 1.26 | 0.92 | 0.12 | 0.16 |
| δ | | | | | | |
| True density ρ (g/cm³) | 2.014 | 2.142 | 1.732 | 1.681 | 2.251 | 2.101 |
| Thermal | 200 | 260 | 120 | 110 | 260 | 280 |
| conductivity (W/m · k) | | | | | | |
| Compressive strength | 35 | 25 | 12 | 15 | 32 | 30 |
| (MPa) | | | | | | |
| Bending strength | 20 | 15 | 7 | 8 | 18 | 20 |
| (MPa) | | | | | | |

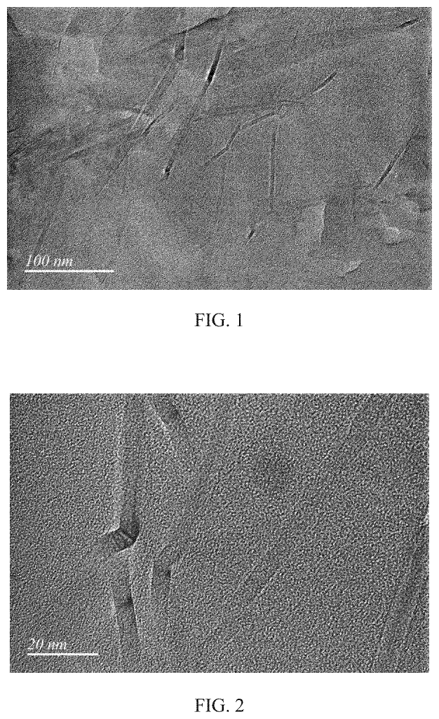

As can be seen from the results of Table 1, the composite carbon materials prepared in Examples 1 to 4 have higher mechanical strength and thermal conductivity than the Comparative Examples 1 and 2. In addition, FIG. 1 and FIG. 2 are TEM images at different magnifications of the composite carbon material prepared in Example 4, the figures illustrate that the graphitic phase in the composite carbon material is dispersed in amorphous carbon in a thickness of nanometer level (≤10 nm). Furthermore, it is demonstrated from HR-TEM observation that the graphitic phases in the composite carbon materials prepared in Examples 1 to 3 are dispersed in the amorphous carbon in a thickness of nanometer level (5-25 nm).

### Example 5

The example was used for illustrating the composite carbon material and the method for producing the same according to the present disclosure.

The preparation method comprises the following steps: the petroleum asphalt with a softening point of 220° C. was used as a matrix material, the asphalt was subjected to crushing and the crushed asphalt was subjected to sieving by a 200-mesh sieve, the obtained screen underflow particles and the natural graphite (200-mesh sieve screen underflow particles, with a carbon content more than or equal to 99.5 wt %) were subjected to stirring and mixing at an ambient temperature according to a mass ratio of 4:1, the mixture was added into a kneader, the mixture was initially processed at an ambient temperature for 3 hours at a rotation speed of 500 rpm under the protection of nitrogen gas, the mixture was then processed for 2 hours in the process of heating to 240° C. at a constant speed, the mixture was subsequently processed at a constant temperature of 240° C. for 6 hours, the mixture was finally processed for 2 hours in the process of cooling to an ambient temperature at a constant speed, the aforementioned process was circulated for 5 times, and the mixture was processed in a total of 65 hours.

The mixture obtained by blending-kneading was placed in an oxidation furnace, and subjected to processing for 8 hours at 260° C. in an air atmosphere; the obtained oxidation product was then put into a carbonization furnace and subjected to carbonization at 1400° C. for 3 hours under the protection of nitrogen gas, and subsequently cooled, thereby obtaining a composite carbon material. The characterization results of the composite carbon material were shown in Table 2.

### Comparative Example 3

The coal pitch with a softening point of 220° C. was used as a matrix material, the pitch was subjected to crushing and the crushed pitch was subjected to sieving by a 200-mesh sieve, the obtained screen underflow particles and the natural graphite (200-mesh sieve screen underflow particles, with a carbon content more than or equal to 99.5 wt %) were subjected to stirring and mixing at an ambient temperature according to a mass ratio of 4:1, the mixture was added into a kneader, the mixture was stirred at an ambient temperature for 96 hours at a rotation speed of 500 rpm under the protection of nitrogen gas.

The mixture obtained by blending-kneading was placed in an oxidation furnace, and subjected to processing for 8 hours at 260° C. in an air atmosphere; the obtained oxidation product was then put into a carbonization furnace and subjected to carbonization at 1,400° C. for 3 hours under the protection of nitrogen gas, thereby obtaining a composite carbon material. The characterization results of the composite carbon material were shown in Table 2.

### Example 6

The example was used for illustrating the composite carbon material and the method for producing the same according to the present disclosure.

The preparation method comprises the following steps: the petroleum asphalt with a softening point of 150° C. was used as a matrix material, the asphalt was subjected to crushing and the crushed pitch was subjected to sieving by a 100-mesh sieve, the obtained screen underflow particles and the artificial graphite (100-mesh sieve screen underflow particles, with a carbon content more than 99 wt %) were subjected to stirring and mixing at an ambient temperature according to a mass ratio of 1:1, the mixture was added into a ball mill, the mixture was initially subjected to ball milling at an ambient temperature for 2 hours at a rotation speed of 600 rpm and a revolution rotation speed of 400 rpm under the protection of nitrogen gas, the mixture was then subjected to the ball milling for 1 hour in the process of heating to 180° C. at a constant speed, the mixture was subsequently subjected to ball milling at a constant temperature of 180° C. for 8 hours, the mixture was finally subjected to ball milling for 1 hour in the process of cooling to an ambient temperature at a constant speed, the process was circulated for 6 times, and the mixture was subjected to ball milling in a total of 72 hours.

The mixture obtained by ball milling was placed in concentrated nitric acid and processed at 60° C. for 2 hours, the processed product was then filtered, the obtained filter cake was washed with deionized water until the pH of the obtained solution was 7, the washed filter cake was finally subjected to forced air drying at 100° C. The dried product was put into a carbonization furnace and subjected to carbonization at 1,500° C. for 3 hours under the protection of nitrogen gas, and then cooled to obtain a composite carbon material. The characterization results of the composite carbon material were shown in Table 2.

### Comparative Example 4

A composite carbon material was prepared according to the method of Example 6, except that the step of oxidation was not performed, the mixture Obtained by ball milling was directly put into a carbonization furnace and subjected to carbonization at 1,500° C. for 5 hours under the protection of nitrogen gas, thereby obtaining a composite carbon material. The characterization results of the composite carbon material were shown in Table 2.

### Example 7

The example was used for illustrating the composite carbon material and the method for producing the same according to the present disclosure.

The preparation method comprises the following steps: the petroleum asphalt with a softening point of 150° C. was used as a matrix material, the asphalt was subjected to crushing and the crushed asphalt was subjected to sieving by a 100-mesh sieve, the obtained screen underflow particles and the artificial graphite (the artificial graphite was 100-mesh screen underflow particles, with a carbon content more than 99 wt %) were subjected to stirring and mixing at an ambient temperature according to a mass ratio of 1:1, the mixture was added into a banbury mixer, the mixture was initially processed at an ambient temperature for 1 hour at a rotation speed of 300 rpm under the protection of nitrogen gas, the mixture was then processed for 1.5 hours in the process of heating to 190° C. at a constant speed, the mixture was subsequently processed at a constant temperature of 190° C. for 5 hours, the mixture was finally processed for 1.5 hours in the process of cooling to an ambient temperature at a constant speed, the process was circulated for 4 times, and the mixture was subjected to banburying in a total of 36 hours.

The mixture obtained by banburying was placed in an oxidation furnace, and subjected to processing in air atmosphere at 240° C. for 8 hours; the obtained oxidation product was put into a carbonization furnace, and subjected to carbonization at 1,400° C. for 3 hours under the protection of nitrogen gas, thereby obtaining a composite carbon material. The characterization results of the composite carbon material were shown in Table 2.

Application Examples 1-3 and Application Comparative Examples 1-2 were used for illustrating the applications of the silicon-carbon composites prepared in Examples 5-7 and Comparative Examples 3-4 on the lithium ion batteries, respectively.

Application Examples 1-3 and Application Comparative Examples 1-2

The composite carbon materials prepared in Examples 5-7 and Comparative Examples 3-4 were further pulverized and classified in a jet mill respectively to obtain composite carbon material powders with a median particle size of 8 μm, and the five kinds of powders were mixed with carbon black, Polyvinylidene Fluoride (PVDF) and N-methyl pyrrolidone (NMP) at a mass ratio of 92:3:5:200 respectively and stirred uniformly, so as to obtain a negative electrode slurry the obtained negative electrode slurry was then coated on copper foil (with the thickness of 10 μm), the coated copper foil was subjected to drying in a vacuum oven at 120° C. and −0.08 MPa for 12 hours to obtain an anode for a lithium ion battery.

The anode for a lithium ion battery was subjected to punching, and respectively assembled into button batteries in a glove box filled with argon gas, wherein the counter electrode was a metal lithium sheet, the electrolyte was selected from 1 mol/L EC+EMC solution of LiPF₆ (the volume ratio of EC to EMC was 1: 1), and the diaphragm was a Celgard2400 diaphragm. The performance of the cell was shown in Table 2.

TABLE 2

| | | Comparative | | Comparative | |
|---|---|---|---|---|---|
| Items | Example 5 | Example 3 | Example 6 | Example 4 | Example 7 |
| d₀₀₂ (nm) of crystal | 0.337 | 0.335 | 0.343 | 0.342 | 0.339 |
| phase | | | | | |
| Crystal phase | 32.1 | 123.4 | 14.2 | 69.1 | 20.1 |
| crystalline grain | | | | | |
| size Lc (nm) | | | | | |
| I₀₀₂/FWHM | 29,448 | 405,888 | 42,573 | 12,2534 | 66,713 |
| I₀₀₂/Iₐₘₒᵣ | 5.2 | 85.9 | 12.8 | 78.3 | 38.4 |
| Normalized | 20.8 | 343.5 | 12.8 | 78.3 | 38.4 |
| I₀₀₂/Iₐₘₒᵣ | | | | | |
| Dispersion | 0.05 | 0.96 | 0.33 | 0.85 | 0.52 |
| coefficient δ | | | | | |
| True density ρ | 1.989 | 1.431 | 1.963 | 1.389 | 1.945 |
| (g/cm³) | | | | | |
| Discharge capacity | 260 | 220 | 276 | 200 | 252 |
| (mAh/g) at 0.1 C | | | | | |
| Discharge capacity | 100 | 40 | 90 | 57 | 77 |
| (mAh/g) at 2 C | | | | | |
| Capacity retention | 38.5 | 18.2 | 32.6 | 28.5 | 30.6 |
| ratio (%) | | | | | |

As can be seen from Table 2, the composite carbon materials prepared in Examples 5 to 7 used as the anode material for a lithium ion battery can improve the discharge capacity retention rate of the lithium ion batteries, as compared with the Comparative Examples 3-4. Furthermore, it is demonstrated by the HR-TEM observation that the graphitic phases in the composite carbon materials prepared in Examples 5-7 are dispersed in amorphous carbon in a thickness of nanometer level (5-30 nm)

The preferred embodiments of the present disclosure have been described above in detail, but the present disclosure is not limited. thereto. Within the scope of the technical idea of the present disclosure, many simple modifications can be made to the technical solution of the present disclosure, including various technical features being combined in any other suitable way, and these simple modifications and combinations should also be regarded as the disclosure of the present disclosure, and all fall within the scope of the present disclosure.

1. A composite carbon material comprising a graphite crystal phase and an amorphous carbon phase, wherein the ratio I₀₀₂/Iₐₘₒᵣ of the peak intensity I₀₀₂ of the graphite crystal phase (002) plane relative to the peak intensity Iₐₘₒᵣ of the amorphous carbon phase as measured by X-Ray Diffraction (XRD) is within a range of 0.1-40, and the content of the graphite crystal phase is not less than 5 wt %.

2. The composite carbon material of claim 1, wherein the normalized ratio I₀₀₂/Iₐₘₒᵣ of the peak intensity I₀₀₂ of the graphite crystal phase (002) plane relative to the peak intensity Iₐₘₒᵣ of the amorphous carbon phase is within a range of 0.1-60.

3. The composite carbon material of claim 1, wherein the ratio I₀₀₂/FWHM of the peak intensity I₀₀₂ of the graphite crystal phase (002) plane relative to the full width at half maximum (FWHM) of the peak is within a range of 1,000-80,000.

4. The composite carbon material of claim 1, wherein the dispersion coefficient δ of the ratio Id/Ig of Id and Ig as measured by Raman spectrum is less than 0.8.

5. The composite carbon material of claim 1, wherein the true density p of the composite carbon material is within a range of 1.8 to 2.3 g/cm³.

6. A method of producing the composite carbon material of claim 1, the method comprising the following steps:
1) subjecting a matrix material and a filler to multi-stage mixing so as to obtain a mixture, wherein the multi-stage mixing comprises:
(1) mixing the matrix material and the filler under an ambient temperature for 1-6 hours; then
(2) blending the matrix material and the filler for 0.5-3 hours in the process of heating to 10-50° C. higher than the softening temperature of the matrix material; then
(3) blending the matrix material and the filler for 2-10 hours at the constant temperature of 10-50° C. higher than the softening temperature of the matrix material; and then
(4) blending the matrix material and the filler for 0.5-3 hours in the process of cooling to the ambient temperature;
circulating the stages (1) to (4) for multiple times, and the total time of the multi-stage mixing is within a range of 10-150 hours;
2-1) oxidizing the mixture, and subsequently carrying out carbonization in a carbonization furnace; or
2-2) subjecting the mixture to mold pressing carbonization in a mold;
wherein the matrix material forms the amorphous carbon phase by carbonization, and the filler is selected from graphite and/or graphene.

7. The method of claim 6, wherein the matrix material in step 1) is selected from the group consisting of coal pitch, petroleum asphalt, mesophase pitch, Direct Coal Liquefaction Residue, heavy aromatic hydrocarbons, epoxy resins, phenolic resins, urea-formaldehyde resins, furfural resins, polyvinyl alcohol, polyethylene glycol, polyvinylidene fluoride, polyacrylonitrile, and a combination thereof;
wherein the matrix material and the filler are in the particulate form, and the mesh number of the matrix material is more than 50 meshes.

8. The method of claim 6, wherein the mass ratio of the matrix material to the filler in step 1) is 1:0.15.

9. The method of claim 6, wherein the multi-stage mixing in step 1) is performed by means of one of ball milling, blending-kneading and banburying or a combination thereof.

10. The method according to claim 6, wherein the oxidation in the step 2-1) is performed in an oxidizing atmosphere, wherein the temperature of the oxidation is within a range of 220-350° C., and the oxidation time is 1-16 hours; or
the oxidation is performed in a strong oxidizing acid, the temperature of the oxidation is within a range of 25-100° C., and the oxidation time is 0.5-12 hours.

11. The method of claim 6, wherein the temperature of the mold pressing carbonization the step 2-2) is within a range of 600-1,600° C., the pressure applied to the surface of the mixture is within a range of 10-50 MPa, and the time of the mold pressing carbonization is within a range of 1-10 hours.

12. The method of claim 6, wherein the method further comprises:
3) subjecting the carbonized product obtained in step 2-1) or step 2-2) to pulverization and grading;
wherein the median particle size of the powder obtained by the step 3) is within a range of 5-20 μm.

13. (canceled)

14. A method of the composite carbon material of claim 1 in a heat dissipation material or a lithium ion battery.
